(19) United States
(12) Patent Application Publication
(10) Pub. No.: US 2024/0135087 A1
(43) Pub. Date: Apr. 25, 2024

(54) MULTI-DOCUMENT INTEGRATED READING

(71) Applicant: ADOBE INC., San Jose, CA (US)

(72) Inventors: Natwar MODANI, Bangalore (IN); Inderjeet Jayakumar NAIR, Indore (IN)

(21) Appl. No.: 17/954,558

(22) Filed: Sep. 28, 2022

(51) Int. Cl. G06F 40/166; G06F 3/0484; G06F 16/93; G06Q 50/18

(52) U.S. Cl. CPC G06F 40/166; G06F 3/0484; G06F 16/93; G06Q 50/18

(57) ABSTRACT

Embodiments of the technology described herein provide a method for generating a unified contract view. The method identifies, within a contract change document, a change instruction for a main contract. The change instruction includes a change introduction and a change content. The method determines an editing intent associated with the change instruction. The method identifies, using the change instruction, a target element in the main contract to be changed. The method generates a unified contract view that depicts the target element modified according to the editing intent and the change content. The method causes the unified contract view to be output for display.

### BACKGROUND

Contracts are ubiquitous in business world. Contracts are negotiated to arrive at mutually acceptable terms before signing. Sometimes, the parties involved may need to update the terms and conditions after the contract has been signed. Rather than cancelling the current agreement and signing a new contract with changed terms and conditions, the parties involved may sign amendments/change documents to change the required parts. When a change document is executed, both the main contract and change document need to be read together to understand the terms and conditions. The main contract does not have (at least partially) the currently prevailing terms and conditions, while the change documents do not have full information and context. The problem is exacerbated as the number of change documents increases.

### SUMMARY

Embodiments of the technology described herein provide an integrated reading experience for multiple documents, such as a main contract and its change document. The integrated reading experience eliminates the need for back-and-forth navigation between the main contract and a change document. The technology described herein receives a main contract and one or more change documents as input. These inputs are used to generate a unified contract view that shows the main contract as modified by the one or more change documents. The unified contract view may be output as part of the integrated reading experience. The unified contract view eliminates the need for users to reference the two or more documents when trying to understand the terms and conditions of the contract that has been modified by one or more change documents.

### BRIEF DESCRIPTION OF THE DRAWINGS

FIG. 1 is an illustration of an integrated reading environment, in accordance with embodiments of the technology described herein;

FIG. 2 provides a diagram illustrating the identification of document elements, in which embodiments described herein may be employed;

FIG. 3 is an illustration of a document's semantic structure, in accordance with embodiments of the technology described herein;

FIG. 4 is an illustration of an integrated reading experience building interface, in accordance with embodiments of the technology described herein;

FIG. 5 is an illustration of an integrated reading view selection interface, in accordance with embodiments of the technology described herein;

FIG. 6 is an illustration of a multi-document interface showing a change document, in accordance with embodiments of the technology described herein;

FIG. 7 is an illustration of a change document used to generate an integrated- reading interface, in accordance with embodiments of the technology described herein;

FIG. 8 is an illustration of an integrated-reading interface showing an insert, in accordance with embodiments of the technology described herein;

FIG. 9 is an illustration of an integrated-reading interface enabling user adjustment of document section identification, in accordance with embodiments of the technology described herein;

FIG. 10 is an illustration of an integrated reading interface enabling user adjustment of document section identification, in accordance with embodiments of the technology described herein;

FIG. 11 provides an example method of generating a multi-document integrated reading interface, in accordance with embodiments of the technology described herein;

FIG. 12 provides an example method of generating a multi-document integrated reading interface, in accordance with embodiments of the technology described herein;

FIG. 13 provides an example method of generating a multi-document integrated reading interface, in accordance with embodiments of the technology described herein; and

FIG. 14 is a block diagram of an example computing environment suitable for use in implementing embodiments of the technology described herein.

### DETAILED DESCRIPTION

Embodiments of the technology described herein provide an integrated reading experience for multiple documents, such as a main contract and its change document. The integrated reading experience eliminates the need for back-and-forth navigation between the main contract and a change document. The technology described herein receives a main contract and one or more change documents as input. These inputs are used to generate a unified contract view within the integrated reading experience that shows the main contract as modified by the one or more change documents. The unified contract view eliminates the need for users to reference the two or more documents when trying to understand the terms and conditions of the contract that has been modified by one or more change documents. Change documents may include an addendum, amendment, child contract, codicil, and the like.

Several technical problems are solved by the technology described herein in order to create the unified contract view. The technical problems are caused by the nature of the main contract and the change document, which are very distinct. The distinctions between the documents make comparison and/or integration of the two documents very difficult for a computing system. A contract may include a sequence of clauses and sections that follow a hierarchical format. On the other hand, a change document may include an introduction and conclusion with one or more change instructions. A single change instruction may reference one portion of the larger contract, possibly referencing hierarchical terms used in the main contract. For example, a single change instruction may specify that a single paragraph in a particular section of the main contract be replaced with a new paragraph provided in the change document. However, the text from the paragraph to be replaced may not be included at all in the change document, which makes identification of the target paragraph in the main contract difficult. Instead, the paragraph may be described according to the organizational terms used in the main contract. Organizational terms can include paragraph titles, list numbers, and the like.

The technology described herein builds a hierarchy of the main contract. The hierarchy may be generated on a document-segment-by-document-segment basis. Contract characteristics, including document organizational terms, for each segment may be identified. The contract characteristics can include section titles, clause titles, segment types, list identifiers, and the like. As used herein, the main contract is an earlier contract document executed between parties and referenced in one or more change documents.

The technology described herein identifies change instructions within the change document. A change instruction can include a change introduction that specifies an edit to be made and identifies a target segment within the main contract. The change instruction can also include change content that is used when making the specified edit. The technology can determine a change intent from the change instruction. Possible change intents include adding content, deleting content, and/or replacing content. The technology can also determine a target segment to be changed by comparing information provided in the change instruction with characteristics of segments within the main contract.

Having identified the target segment in the main contract, the change intent, and change content (in the case of an addition or replacement), the change is implemented on the contract to produce the unified contract view, which is output as part of an integrated reading experience. The integrated reading experience allows the user to view the main contract as updated by the change document.

The unified contract view is different from document merger operations, at least, because the change document includes content that is not merged or included as part of the integrated reading experience. A change document often includes an introduction, conclusion, and one or more change instructions. Were a merge operation to be performed on the change document and the main contract document, the resulting document would include the introduction and conclusion. Further, change instructions in a change document include a change introduction that specifies the change operation (e.g., add, replace, delete) to be performed. The change introduction often describes a portion of the contract that is changed by the change instruction. However, it is not desirable to include the change instruction in order to understand how the change document changes the main contract. Instead, the technology described herein provides a view that changes the original content according to the instruction, which eliminates the need for the user to read the change instruction.

The technology described herein improves a computer's ability to understand human language. In particular, the technology described herein improves the ability of a computer to understand an editing intent and portion of a first document to be edited in response to change instructions in a second document. The portion of the document to be edited is identified by first understanding the semantic arrangement of the main document. First understanding the semantic arrangement of document sections and associated section labels, allows section labels from a first paragraph be associated with a subsequent paragraph that is unlabeled or otherwise ambiguously associated with the section. The hierarchy built from the semantic arrangement allows the document structure to be understood by the computer and used to more accurately identify otherwise ambiguous sections described in a change document.

The editing intent is better understood by using a special purpose editing intent detector that is trained to detect editing intents that are frequently found in a change document. The editing intent is also better understood by first identifying a portion of a change document in which the editing intent is likely to be found. In combination, these and other aspects of the technology identify change intents and portions to be edited with higher accuracy than found in existing technology. A result of these improved technologies is the ability to create an accurate unified contract view that accurately communicates a new meaning of the contract created by the change document.

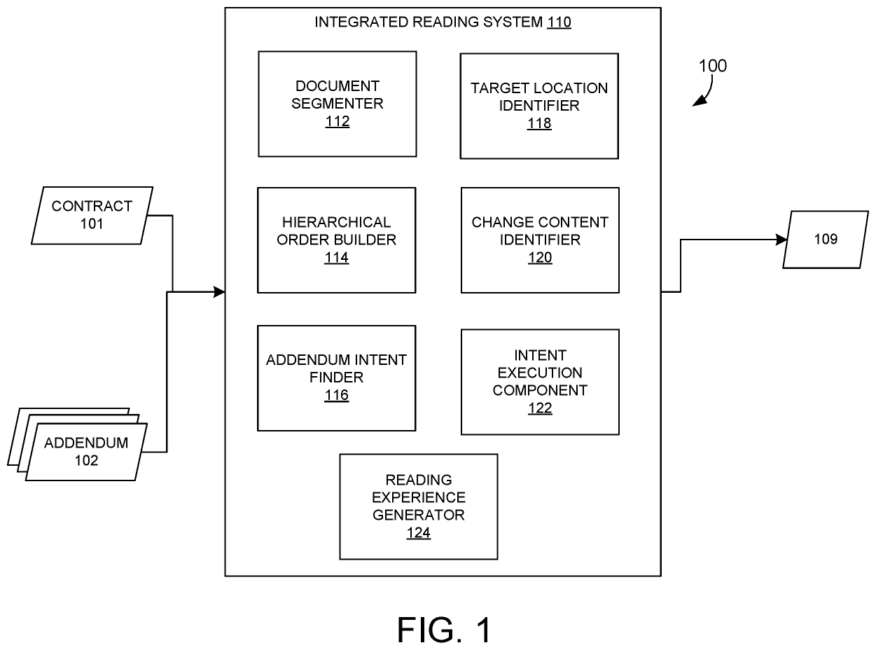

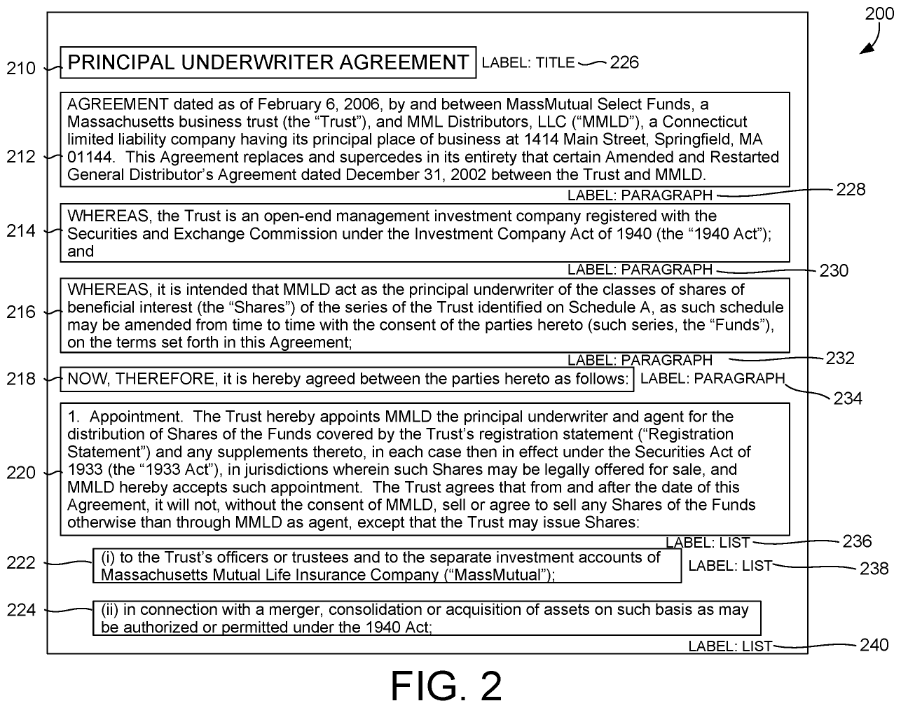

Turning now to FIG. 1, an integrated reading environment 100 is shown, in accordance with implementations of the present disclosure. The environment 100 includes an integrated reading system 110 that receives a contract 101 and one or more change documents 102 as input and generates an integrated-reading interface 109 as output. The integrated-reading interface 109 may generate an integrated reading view for each change document. Example integrated-reading interfaces are shown in FIGS. 2-10. In aspects, operations may be split between client-side devices and server-side devices. Further, the components shown may interact with computing devices not shown in FIG. 1, such as user devices. For example, various user interfaces generated by, or with information generated by the components shown, may be displayed on a user device, such as a laptop or smartphone.

The arrangements described herein are set forth only as examples. Other arrangements and elements (e.g., machines, interfaces, functions, orders, and groupings of functions, etc.) may be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions are carried out by a processor executing instructions stored in memory.

Moreover, these components, functions performed by these components, or services carried out by these components are implemented at appropriate abstraction layer(s), such as the operating system layer, application layer, hardware layer, etc., of the computing system(s). Alternatively, or in addition, the functionality of these components and/or the embodiments of the technology described herein are performed, at least in part, by one or more hardware logic components. For example, and without limitation, illustrative types of hardware logic components include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein regarding specific components shown in example environment 100, it is contemplated that in some embodiments functionality of these components are shared or distributed across other components.

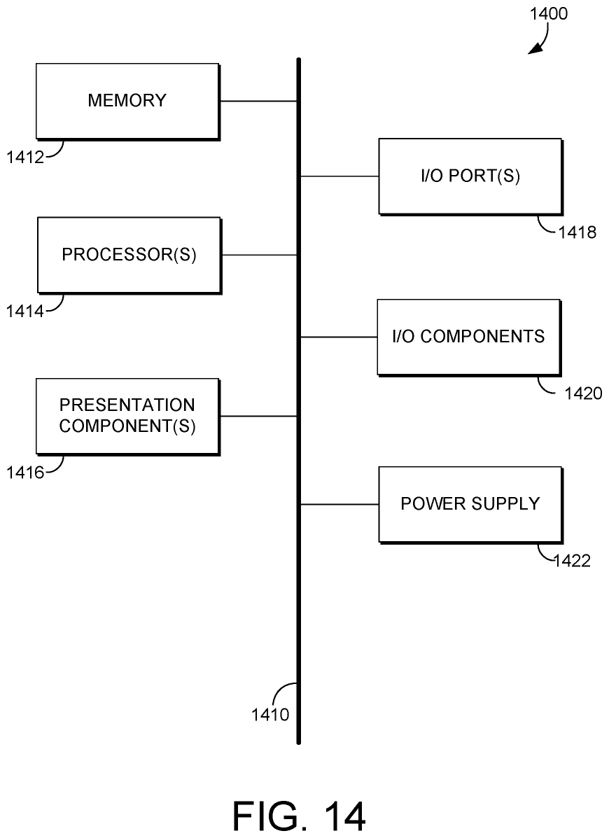

Through not shown, a user device is any type of computing device capable of use by a user. For example, in one embodiment, a user device is of the type of computing device described in relation to FIG. 14 herein. In various embodiments, a user device is a personal computer (PC), a laptop computer, a mobile or mobile device, a smartphone, a tablet computer, a smart watch, a wearable computer, a virtual reality headset, augmented reality glasses, a personal digital assistant (PDA), a mP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

The contract 101 and change document 102 may be provided as electronic documents. For example, the electronic documents could be in proprietary formats, such as Portable Document Format (.PDF) or Microsoft Word (.DOC). The electronic documents could be in other formats, such as text (.txt), rich text (.rtf), or eXtensible Markup Language (XML). In aspects, the contract 101 and change document 102 could be presented as an image file, such as a Bitmap (BMP) or Joint Photographic Experts Group (JPEG).

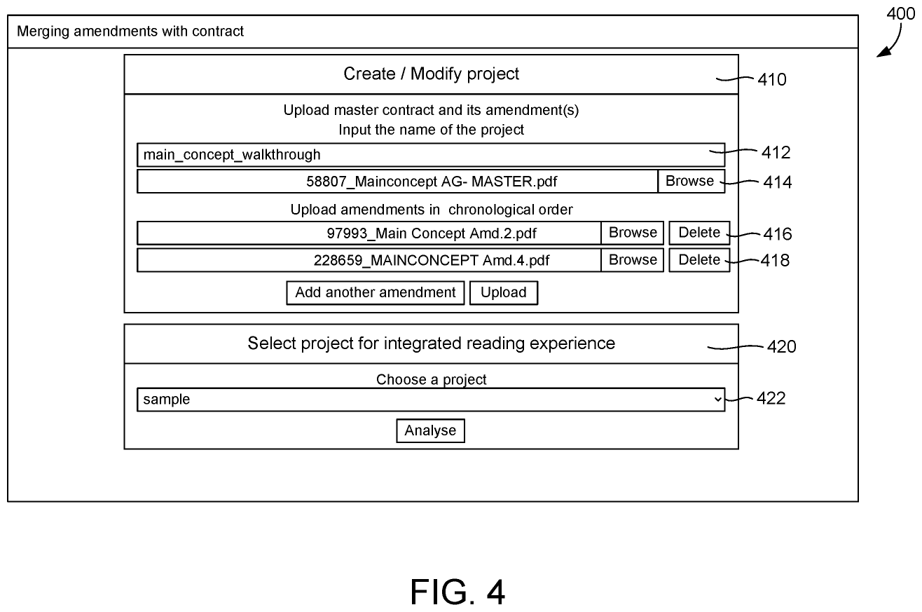

The integrated reading system 110 receives the contract 101 and the change document 102 and produces the integrated-reading interface 109. The integrated reading interface may be output through a user device, such as a laptop. The integrated-reading interface 109 is described with more detail with reference to FIGS. 4-10. The integrated reading system 110 includes a document segmenter 112, a hierarchical order builder 114, a change-document intent finder 116, a target location identifier 118, a change content identifier 120, an intent execution component 122, and a reading experience generator 124.

The document segmenter 112 identifies structural segments within the contract and change document(s). The document segmenter 112 parses the contract and change document(s) by extracting the structural segments. The structural segments are structurally coherent units within the document structure, such as TITLE, TABLE, LIST, HEADING, PARAGRAPH, etc. The segmentation enables the integrated reading system 110 to represent the contract and change document(s) in a format convenient for generating the integrated-reading interface 109.

In an aspect, the document segmenter 112 identifies structural elements by finding the bounding boxes and associating a label with each of the extracted elements, such as headings (H1, H2, . . . , H6), list elements, paragraphs, titles, tables, etc. The bounding box may be defined using coordinates that locate the bounding box within the document. The content, such as text, associated with a structural element fits within the dimensions of the bounding box.

The document segmenter 112 may generate a list of structural elements associated with it. For a document [symbol] , the ordered list of n extracted elements may be denoted by [symbol] ={x₁, x₂, . . . , xₙ}. The ordering is indicative of the natural reading order associated with [symbol] . In most English language documents, the reading order is from top to bottom and left to right. Different languages may use different reading order. The language of the text may be determined and used to determine the reading order. Each element may contain the following properties:
x.TYPE: Type of the element such as H1, H2, TITLE, PARAGRAPH, LIST
x.TEXT: Content contained in the element. For instance, a PARAGRAPH typed element would contain the corresponding paragraph text in this property.
x.BOUNDING BOX: Contains the bounding box co-ordinates associated with x.

After the extraction of structural elements in appropriate order, the document segmenter 112 may find a clause title and section associated with each element. The clause title and section may be referenced in the change document. The assigned title and clause title can help find the target element in the main contract. For example, a change document may state: “Section 1.2 “Title to Product” is hereby amended by adding the following to the end of the paragraph:”. The change clause in the above example uses the clause title “Title to Product” and section number “1.2” to refer to the desired target element.

Identifying the section and/or clause title may begin by splitting text within a structure element into individual sentences. Thus, for every x∈ [symbol] , the document segmenter 112 may split x.TEXT into sentences. In general, a clause title and/or section will be at the beginning of sentences, if it is associated to any. In an aspect, heuristics using the sentence lengths may be used to determine the clause title/section associated with each element. The heurist may look for section characters, such as numbers, letters, or roman numerals followed by a period. Similarly, the title may be a single word or short phrase. For instance, the element with text “1. Appointment. The Trust hereby appoints MMLD . . . ” is associated with title “Appointment” and section “1.”. Once a section and/or clause title is determined it may be associated with the element (.TITLE=“Appointment” and x.SECTION=“1.”.)

Not all structural sections are associated directly with a clause title and or section. While this step uses the text in x to find the title and section associated with it, the document segmenter 112 may not use this to associate titles from other elements. For example, if an element of type “H1” entails three “PARAGRAPH” typed elements, then this method cannot be used for propagating the title extracted from the “H1” typed element to the elements entailed by it. However, the hierarchical order of elements may be used to associate a section and or clause title to related structural sections.

The hierarchical order builder 114 finds the semantic structure associated with the documents by establishing hierarchical relations between the extracted structural elements. The semantic structure of the document is a collection and ordering of relationships among the structural elements (for instance, the containment relation between a clause and its sub-clauses). The semantic structure may be represented using a tree structure. This tree structure may incorporate detailed information with each structural element.

This hierarchical organization is formed from the set [symbol] ∪{ROOT}, where ROOT is a special node that encompasses all the elements within the main contract. This hierarchical organization is represented by a tree with ROOT as the root of this tree. A node x in the tree contains every other node present in its subtree. In other words, the TITLE/SECTION property associated to a node can be propagated to every other node in its subtree. For example, in FIG. 2. the elements with SECTION ‘(i)’ and ‘(ii)’ are associated with the TITLE ‘Appointment’ because Appointment is the title of the parent element of those two elements. Another property of this tree is that the reading order among the elements is recoverable through pre-order traversal of the tree. This property may be used when executing an algorithm for finding the hierarchical structure.

An algorithm may process the ordered list [symbol] to construct the hierarchical tree for document [symbol] . The algorithm maintains a data structure [symbol] , representing the tree, and reference to the element/node c that was recently added to [symbol] . These variables are updated in every iteration. The algorithm iterates over the elements in [symbol] in the same order and let x be the element from [symbol] in the current iteration. There are two ways for adding x to [symbol] : x is either the next child of c or x is the next child of one of the ancestors of c. Thus, x is added using the above two rules.

To find the element (either c or one of its ancestors) to which x must be added, hierarchical order builder 114 keeps on updating c to its parent until RANK(c.TYPE)>RANK(x.TYPE). RANK values for different types are provided in Table 1. Thereafter, hierarchical order builder 114 concludes the iteration by updating c to x. Pseudo code for this algorithm is shown below.

TABLE 1
Mapping TYPE with RANK.

| TYPE | RANK |
|---|---|
| LIST | 0 |
| PARAGRAPH | 1 |
| H6 | 2 |
| H5 | 3 |
| H4 | 4 |
| H3 | 5 |
| H2 | 6 |
| H1 | 7 |
| TITLE | 8 |
| ROOT | 9 |

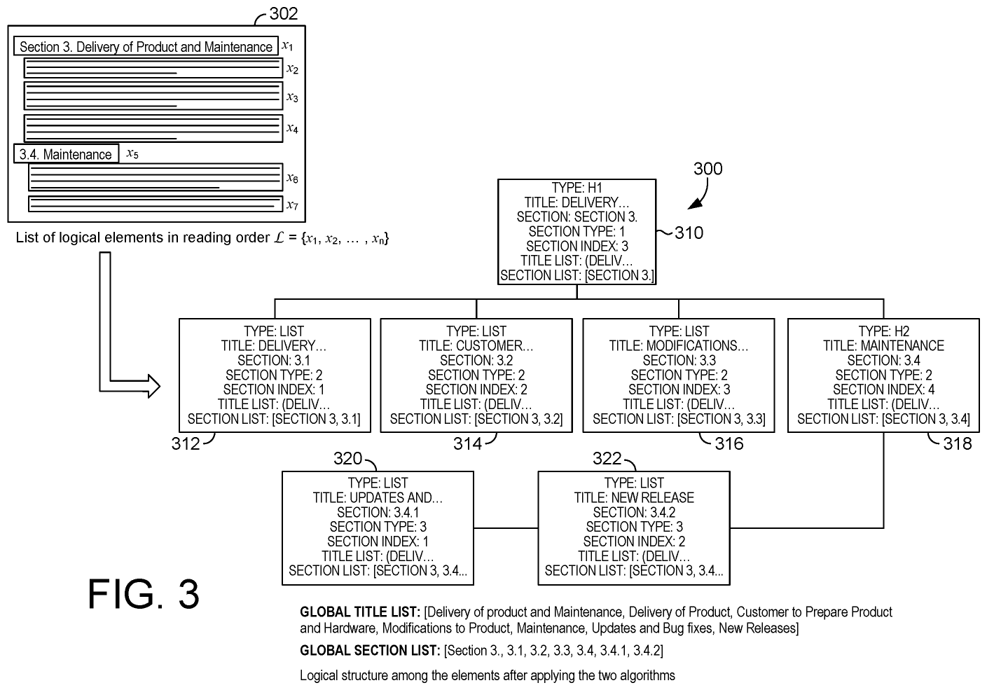

FIG. 3: Pseudo code for extracting hierarchical structure.

| | |
|---|---|
| Require: [symbol] = [x₁, x₂, ... , xₙ] | List of structural elements |
| c ← ROOT | sorted by reading order |
| [symbol] ← c | |
| for i = 1 to ∥ [symbol] ∥ do | |
| x ← [symbol] [ [symbol] ] | |
| while RANK(x. TYPE) ≥ | |
| RANK(c. TYPE) do | |
| c ← c. PARENT | |
| end while | Selecting appropriate |
| | element to add x |
| c. ADD(x) | Updating c to its parent |
| c ← x | |
| end for | x is added as the next child of c |
| Return [symbol] | |

While this algorithm works (under the assumption of correct inference of structural elements) in constructing hierarchical structure from [symbol] , this only exploits the differences in TYPE attribute for building the tree. Thus, successive ‘LIST’ typed elements would be placed at a same hierarchical level when following the above-described algorithm. Contracts, however, often contain long sequences of ‘LIST’ typed elements associated with varied hierarchies. Thus, to enable propagation of TITLE and SECTION property among ‘LIST’ typed elements, a post-processing algorithm may be used to establish hierarchical ordering among ‘LIST’ typed elements.

In the post-processing algorithm, [symbol] is defined as the consecutive list of ‘LIST’ typed elements in reading order. Each element may possess these attributes: TYPE, SECTION, TEXT, BOUNDING BOX. These elements may be augmented by adding the property of SECTION TYPE and SECTION INDEX. SECTION TYPE is used to associate identity to section styles. For instance, all the sections in [1., 2., . . . ] are associated with a common SECTION TYPE which will be different for the sections in [a), b), . . . ] or [(i), (ii), . . . ]. Moreover, for each section, a SECTION INDEX is assigned. The SECTION INDEX is the position of the character within the list of sections corresponding to its SECTION TYPE. For instance, SECTION ‘e)’ is associated with the SECTION INDEX, 5.

Let [symbol] be the reference to the data structure storing the hierarchical ordering among the elements in [symbol] and \tilde{c} be the most recent element added to the tree. The list of elements along the path from root of [symbol] to \tilde{c} (including \tilde{c}) is also stored in [symbol] . The post-processing algorithm iterates over the elements in [symbol] and adds the corresponding element in every iteration. Let the element to be added at the current iteration be \tilde{x}. Like the previous algorithm, it can be shown that \tilde{x} can either be added as the next child of \tilde{c} or the next child of one of its ancestors. To find the suitable element to which \tilde{x} is to be added, the \tilde{c} is removed from [symbol] and \tilde{c} is updated to its parent until the following condition is satisfied:

$$∃ \tilde{y} ∈ \tilde{𝒥} s . t \tilde{y} . SECTION TYPE = \tilde{x} . SECTION TYPE ∧ \tilde{y} . SECTION INDEX + 1 = \tilde{x} . SECTION INDEX ∧ \tilde{y} . BOUNDING BOX . LEFT \approx \tilde{x} . BOUNDING BOX . LEFT$$

The above condition may be represented as Condition( [symbol] ,\tilde{x}) for notational convenience while specifying the pseudo code for this post-processing algorithm (as shown below). If the Condition( [symbol] ,\tilde{x}) evaluates to true, then there is an element \tilde{y} in [symbol] which lies in the same hierarchical level as that of \tilde{x} and it immediately precedes \tilde{x} in terms of section properties. Once \tilde{y} is removed from [symbol] , \tilde{x} is added to the \tilde{y}'s parent. The hierarchical order builder 114 then proceeds with the next iteration. Using these two algorithms, hierarchical order builder 114 is able to capture the complete hierarchical information in the document. The hierarchical information is then used for TITLE/SECTION propagation from a section that is directed associated with a TITLE/SECTION to a child section that is not. A document can have multiple subsequences of consecutive LIST typed elements and this algorithm may be applied for each of these subsequences separately.

Pseudo code for extracting hierarchical structure
from the list of consecutive LIST typed elements.

| | |
|---|---|
| Require: [symbol] | List of consecutive LIST |
| \tilde{c} ← ROOT | typed elements |
| [symbol] ← c | |
| [symbol] ← [ ] | |
| for i = 1 to ∥ [symbol] ∥ do | |
| \tilde{x} ← [symbol] [ [symbol] ] | |
| while Condition( [symbol] , \tilde{x}) do | Selecting appropriate |
| | element to add \tilde{x} |
| \tilde{c} ← \tilde{c}. PARENT | Updating c to its parent |
| [symbol] . POP( ) | Remove the most |
| end while | recently added |
| \tilde{c}. ADD(\tilde{x}) | element from [symbol] |
| [symbol] . APPEND (\tilde{x}) | \tilde{x} is added as the next child of \tilde{c} |
| \tilde{c} ← \tilde{x} | \tilde{x} is added to [symbol] |
| end for | |
| Return [symbol] | |

After deriving the semantic structure of the document (either the main contract or change document), the hierarchical order builder 114 may augment each of the structural elements with the additional properties: TITLE LIST and SECTION LIST. TITLE LIST (SECTION LIST) for an element x is a list of titles (sections) formed by collating the TITLE (SECTION) property of x and its ancestors. This augmentation allows properties to an element to be associated with another element by propagating information from other elements. This information may be used to find an appropriate target element for committing a change from the change document.

For the elements in the main contract, global properties may be defined. The global properties may be called GLOBAL TITLE LIST and GLOBAL SECTION LIST, where GLOBAL TITLE (SECTION) LIST is formed by collating TITLE (SECTION) LIST property from all the elements in main contract. GLOBAL TITLE LIST is interpreted as the type of clauses and other topics contained in the main contract. This property may be used to formulate target location specification from the changes in the change document.

The change-document intent finder 116 determines what type of change is made by a change document. A first step may be to identify parts of a change document that describe the changing being made. A change document may include multiple parts. For example, a change document may include introductory paragraph(s), change instructions (segments describing changes), concluding paragraph(s), and signature blocks. Introductory paragraphs may enumerate the parties concerned with the main contract, date of execution, and the like. Introductory paragraphs may include other information, such as a description of the rights and responsibilities of the parties. The introduction may also include a statement asserting that the statements in the main contract, other than the changes mentioned in the change document, remains valid. The concluding paragraphs may contain signatures of the involved parties stating that they agree to the changes described.

The one or more change instructions form the core of the change document. A change instruction describes the type of change (delete, insert, and replace) being made. The change instructions can include a change introduction followed by a change content portion. The change introduction can be used for identifying the intent. The change content defines that substantive change being made by the change instruction. Thus, the change-document intent finder 116 identifies the change instructions (in contrast to the introductory and concluding content) and finds the corresponding change content.

As described previously, the document segmenter 112 may generate a list of document segments within the change document. The change-document intent finder 116 filters out the segments that do not describe change to identify change instructions. In one aspect, the change instruction is identified by detecting the presence of “action” words. The segments that describe the changes contain an action word that can be used for intent identification as well. An example list of action words with their corresponding intent is specified in Table 2.

The change-document intent finder 116 may find an intent by mapping one or more words in the change instruction to a corresponding intent. Aspects of the technology may identify one of three different intents. The three intents include deleting, adding, and replacing. For a change instruction with only a single action word, the intent is identified by mapping the single action word to the intent. On the other hand, if two action words that map to different intents (e.g., deleted and add) are present in conjunction, then the element's intent is inferred as ‘Replace’. After the identification of change-describing segments along with their intent, the target location identifier 118 extracts information for identifying a target element (target location specification) for each of these change instructions.

TABLE 2

| Action words | Intent |
|---|---|
| delete, deleted, deleting, deletion, remove, | Delete |
| removed, removing, removal, erase, erasing, | |
| erased, discard, discarded, discarding | |
| add, added, adding, addition, insert, inserting, | Insert |
| insertion, inserted, append, appended, appending | |
| replace, replace, replacing | Replace |

The target location identifier 118 identifies the segment within the main contract that should be changed by a change instruction in the change document. The target location identifier 118 may use the GLOBAL TITLE LIST and the GLOBAL SECTION LIST for identifying phrases that help identify the target element within the main contract. Specifically, for each change instruction, the target location identifier 118 may define additional properties: TARGET TITLE LIST and TARGET SECTION LIST. Formally, for a change instruction x in the change document, the definition for x. TARGET TITLE (SECTION) LIST is given below:

x.TARGET TITLE(SECTION)LIST={v∈GLOBAL TITLE(SECTION) LIST|v∈x.TEXT}

The target location identifier 118 may store the titles (sections) from GLOBAL TITLE(SECTION) LIST that occurs in x.TEXT. These properties provide key information that can be used for locating the appropriate target element from main contract.

The target location identifier 118 identifies the location by analyzing change instruction details and contract segments details. These details have been identified by the previously described components. From the main contract and change document, the integrated reading system 110 extracted their structural elements and established hierarchical ordering among the elements (semantic structure extraction). This hierarchical ordering enabled propagation of the TITLE and SECTION property from one element to child elements and allowed the integrated reading system 110 to augment the respective semantic structures with the TITLE LIST and SECTION LIST property. The integrated reading system 110 also populated the property of GLOBAL TITLE LIST and GLOBAL SECTION LIST for the main contract, which is used to identify a target location for the changes content in the change instruction. The change-document intent finder 116 identified the change instructions from the list of structural elements in the change document along with their respective change intent. For each of change instructions, the target location identifier 118 identifies a target location specification by defining new properties: TARGET TITLE LIST and TARGET SECTION LIST.

A method used to identify the target location may be described using the following notations. SIM (s₁, s₂) denotes Jaccard Similarity between the sets s₁ and s₂. [symbol] _{c} denotes a random indicator variable, which outputs 1 if the Boolean valued function C evaluates to true. Let [symbol] denote the ordered list of structural elements in the master contract and let an arbitrary change instruction by x. We now describe the procedure for finding the target element for x. For every element v∈ [symbol] , we compute the following:

Score(v,x)= [symbol] _{SIM(v.TITLE LIST,x.TARGET TITLE LIST)>0}×(SIM(v.TITLE LIST,x.TARGET TITLE LIST)+SIM(v.SECTION LIST,x.TARGET SECTION LIST))

For each element in [symbol] , the target location identifier 118 computes the sum of Jaccard similarity for the title and section property if there is any overlap in the associated titles, otherwise the target location identifier 118 sets the score to 0. Thereafter, the target location identifier 118 declares the segment in the main contract with maximum score to be the target element of x. The motivation of introducing an indicator variable in the score computation stems from the fact that the SCORE(v,x) can be sufficiently high even if the SIM(v. TITLE LIST, x. TARGET TITLE LIST) is 0 as the elements belonging to different headings can have very similar SECTION LIST properties. At the same time, it may not be desirable to rule out the influence of the SECTION LIST property in finding the appropriate target element as changes in the change document often reference SECTION attributes for the target location specification.

The change content identifier 120 identifies the change content in a change instruction. It should be noted that the change content identifier 120 may not need be involved if the intent is delete. On the other hand, if the intent is to replace or insert for a change introduction segment (identified through action words) x, then the change content to be inserted may be consecutive elements immediately succeeding x. An algorithm may be used to identify change content associated with the change instruction x. Broadly, the algorithm may determine when a topical shift occurs between consecutive elements and use the detected shift to form a boundary for the change content. The ordered list of structural elements succeeding x may be designated by [symbol] ₓ. A topical shift detection model [symbol] (., ., θ) may be used in this algorithm, where θ denotes the set of parameters associated with the model. For elements x₁ and x₂, [symbol] (x₁.TEXT, x₂.TEXT, θ) denotes the extent of topical difference between x₁.TEXT and x₂.TEXT.

The change content identifier 120 may use a user-defined hard threshold τ with the implication that if [symbol] (x₁.TEXT, x₂.TEXT, θ)<τ, then both the elements are topically coherent and part of the same change content. If outside the defined threshold, then the elements are not topically coherent and not part of the same change content. Thus, the change content identification algorithm initializes a context variable k with the text in first element of [symbol] ₓ. In aspects, k is defined for the associated content for x that will be inserted to the main contract. The algorithm keeps on adding text to k from the succeeding elements of [symbol] ₓ as long as the added text is topically coherent with k. If the algorithm detects a change-content element in a certain iteration that is not topically coherent (e.g., within a threshold), then algorithm terminates for x. The change content identifier 120 may then re-initialize the algorithm for the current element to start building a second change content. The pseudo code for this algorithm is shown below. Change documents may enclose the content to be inserted with markers like quotes/inverted commas. Under such cases, the change content identifier 120 may use these markers for finding the content. While the algorithm described above (and shown below as Algorithm 3). After the content is identified, other information, such as TITLE, SECTION, TYPE, etc. may be copied from elements in [symbol] ₓ and assigned to the change content.

Algorithm 3 Algorithm for finding the associated
content to be inserted for a change describing element x

| | |
|---|---|
| Require: x, [symbol] ₓ | Change describing element |
| k ← [symbol] ₓ[1]. TEXT | and immediately succeeding |
| for i = 2 to ∥ [symbol] ∥ do | list of elements respectively |
| \tilde{k} ← [symbol] ₓ[ [symbol] ]. TEXT | |
| if [symbol] (k, k, θ) > τ ∨ CHECK | CHECK INTENT evaluates to |
| INTENT( [symbol] ₓ[ [symbol] ]) then | true if the argument is a |
| break | change describing element |
| end if | |
| k ← k + \tilde{k} | |
| end for | |
| Return k | |

The topical shift model may be a transformer-based architecture. This may be a locally informed model. The model may takes a pair of paragraphs as input and predict a topical shift between them. This model may be trained over many legal documents including Terms of Service agreements, where the labelling for a pair of paragraphs was done based on whether they occur under a same section heading. In other words, paragraphs in the same section within the training data are identified in the training data as having the same topic.

The intent execution component 122 executes the intended change on the content of the segment at the target location to generate the integrated reading experience content. Different actions are taken based on the change intent. If the intent is deletion, the identified target element is deleted from the main contract. This deletion may be executed by removing the node corresponding to the target element from the semantic structure. The main contract may then be reconstructed by pre-order traversal of the modified structure.

If the intent is replace, the content to be inserted is used to update the TEXT property of the target element. The semantic structure is unchanged.

If the intent is to insert, a new element is created for the main contract with the change instruction's change content as the TEXT property and all the other properties are populated from information gathered by the change content identifier. This element is appended as the target element's next child. The property of TITLE (SECTION) LIST for this new element is formed by collating its respective TITLE (SECTION) property with the target element's TITLE (SECTION) LIST.

The reading experience generator 124 causes the integrated-reading interface 109 to be output to a user device. Example integrated-reading interface 109 examples are described with reference to FIGS. 4-10.

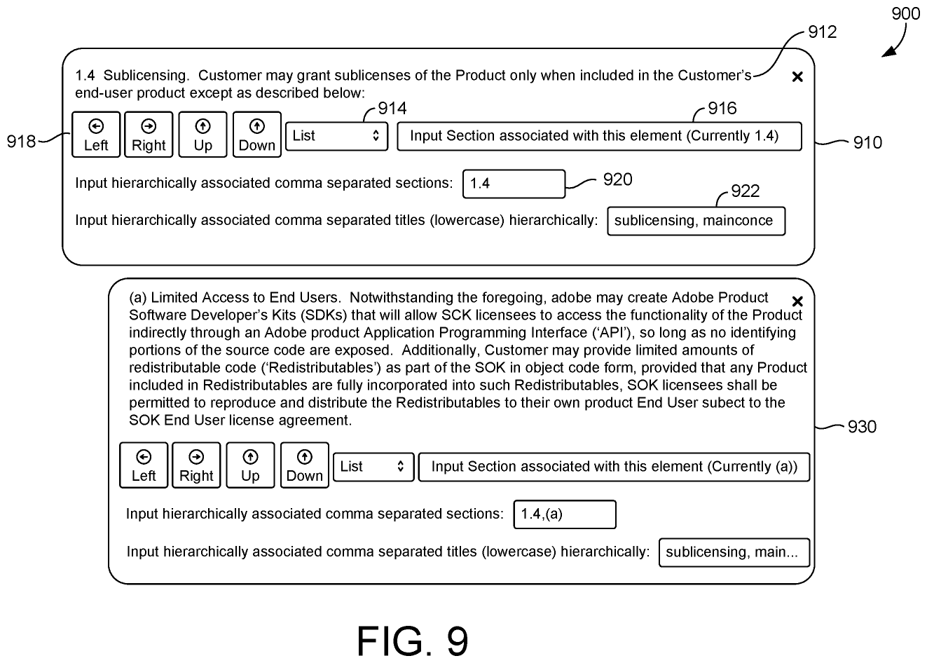

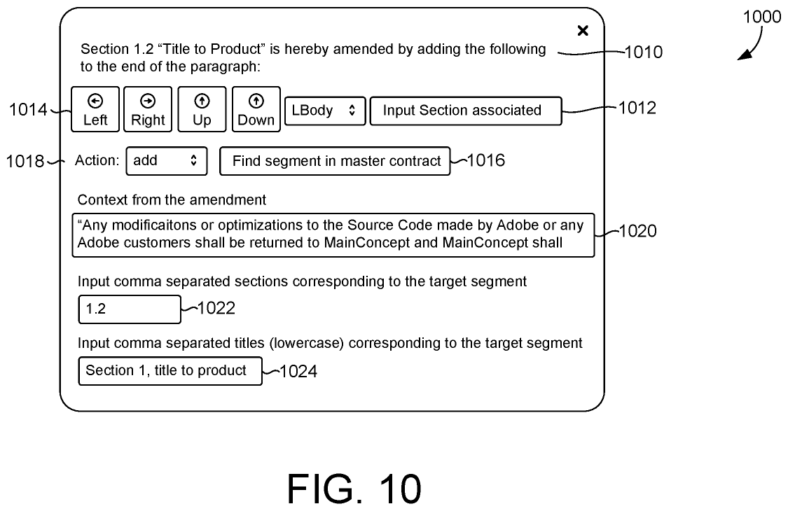

Turning now to FIG. 2, a diagram illustrating the identification of document segments is shown, according to aspects of the technology described herein. As mentioned, and the document segmenter 112 may identify segments within a document, such as a main contract. The document segments may be associated with a title. FIG. 2 shows a portion of a main contract 200 with a plurality of identified segments and associated titles. The identification of the segments and associated titles is shown for the sake of illustration. Implementations of the technology described herein, need not display the segments, bounding boxes, and associated titles. However, in some implementations, especially in connection with allowing the user to correct titles and hierarchy associated with a segment, the bounding boxes and titles may be displayed, as described with reference to FIGS. 9 and 10.

The segments in FIG. 2 include a first segment 210 with the label ‘title’ 226. A second segment 212 is assigned a label ‘paragraph’ 228. A third segment 214 is also assigned a label ‘paragraph’ 230. A fourth segment 216 is similarly associated with the label ‘paragraph’ 232. The fifth segment 218 is also associated with the label ‘paragraph’ 234. The six segment 220 is associated with the label ‘list’ 236. The seventh segment 222 is also associated with the label ‘list’ 238. The eighth segment 224 is similarly associated with the label ‘list’ 240.

Turning now to FIG. 3, an illustration of a document's semantic structure is shown, according to aspects of the technology described herein. The semantic structure may be represented as a hierarchy 300 with element x₁ as the parent node 310. The parent node 310 corresponds with the x₁ segment in the main contract 302. As can be seen, each identified segment within the main contract 302 is associated with a segment reference x. The first child node 312 corresponds with the x₂ segment. The second child node 314 corresponds with the x₃ segment. The third child node 316 corresponds to the x₄ segment. The fourth child node 318 corresponds to the x₅ segment. The fifth node 320 and sixth node 322 are child nodes of the fourth child node 318. The fifth node 320 corresponds to the x₆ segment. The sixth child node corresponds to the x₇ segment.

Additional characteristics may be associated with each node in the hierarchy. For example, each node may be associated with a title characteristic, section characteristic, section type characteristic, section index characteristic, title list characteristic and section less characteristic. The values associated with these characteristics may combined to uniquely define each node.

Turning now to FIG. 4, an illustration of an integrated reading experience interface is shown, according to aspects of the technology described herein. FIG. 4 illustrates a starting page 400 used to select a main contract and one or more change document's the become input to the integrated reading experience. The integrated reading experience may be stored as a project. To start a new project or modify an existing one the user might interact with controls under the create/modify project interface 410. The create/modify project interface 410 allows a name to be given to a new project through the name interface 412. The create/modify project interface 410 may also allow user to select an existing project to modify.

The main contract input interface 414 allows the user to designate a main contract document. The user can browse local and/or remote files to select the main contract document. The change-document interface 416 allows a first change document to be designated. The second change-document interface 418 allows a second change document to be designated. Once two change documents are designated, a third change-document interface (not shown) may appear. In aspects, instructions may be provided to designate the change documents in order of execution date. The project selection interface 420 allows an existing project to be selected for viewing through the selection interface 422. Upon opening an existing project for starting a new one, the user may be taken to an integrated-reading interface.

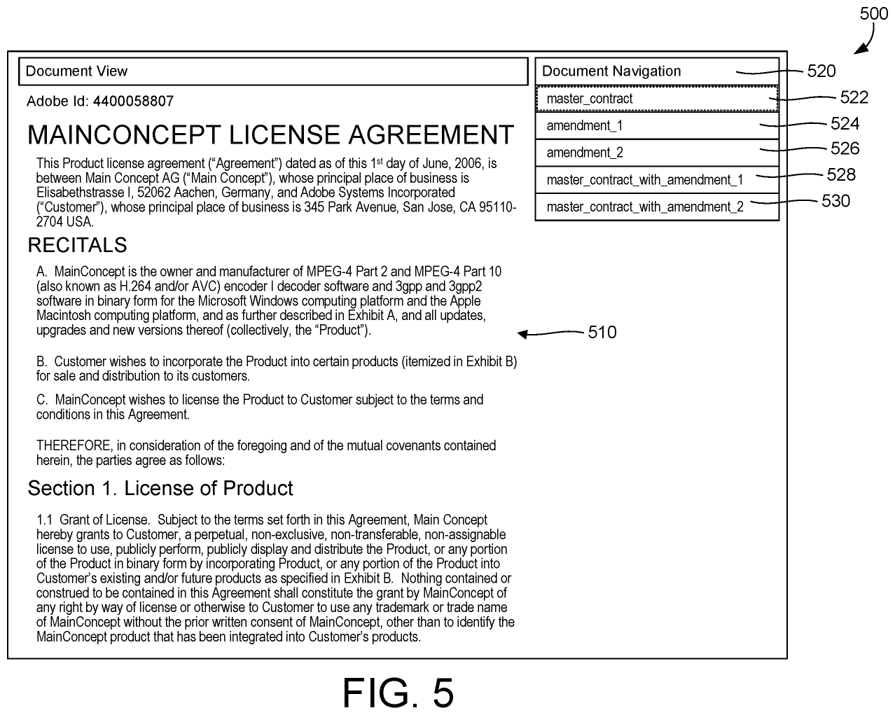

Turning now to FIG. 5, an illustration of an integrated view selection interface is shown, according to aspects of the technology described herein. The view selection interface 500 allows the user to select an integrated reading view to be displayed in the contract view interface 510. The view selection control 520 allows the user to select a main contract view 522, a first change document view 524 a second change document view 526, an first integrated reading view for the first change document 528, or a second integrated reading view for the second change document 530. The main contract view 522 allows the user to view the main contract unchanged by any change documents. The first change document view 524 allows the user to view the first change document in isolation. The second change document view 526 allows the user to view the second change document in isolation. The first integrated reading view for the first change document 528 allows the user to view the main contract as modified by the first change document. The second integrated reading view for the second change document 530 allows the user to view the main contract as modified by the first change document and the second change document. Upon selecting any of the view selection controls 520, the view presented in the contract view interface 510 will change to correspond to the selected view.

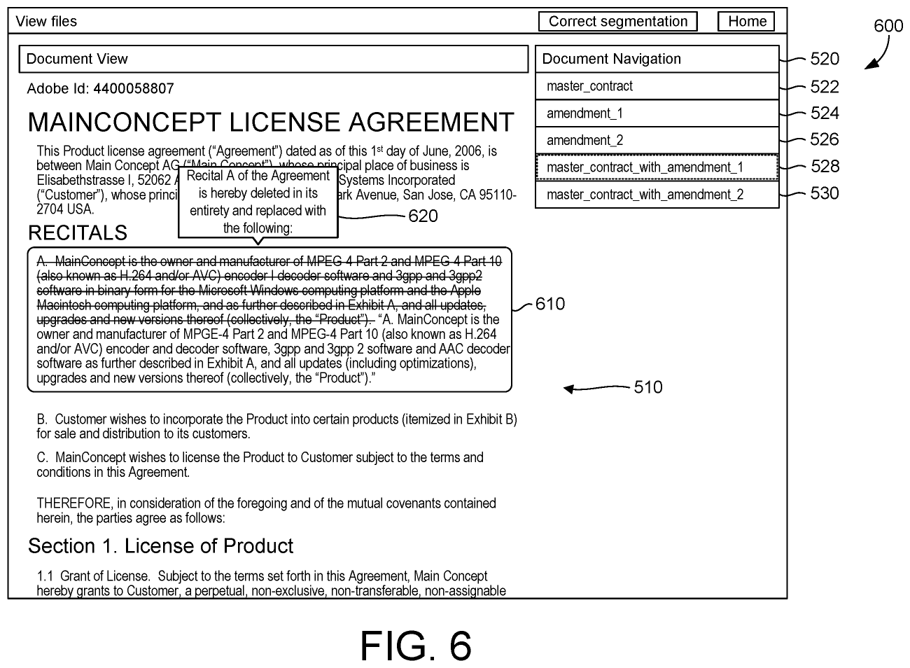

Turning now to FIG. 6, an illustration of an integrated interface displaying a change document view is shown, according to aspects of the technology described herein. As can be seen, the first change document view 528 was selected. In response, an integrated reading experience that shows the main contract as changed by the first change document is displayed in the contract view interface 510. The updated segment 610 illustrates a replacement of original language from the main contract with new language from the first change document. In the integrated reading experience shown, the replaced language is shown with a single strikethrough to indicate it has been deleted. In other implementations, the replaced language from the main contract could simply not be shown with only the replacement content shown from the change document. The updated segment 610 may be shown with a bounding box to emphasize that this segment has been changed by a change document. Upon selecting the updated segment 610, a change introduction interface 620 may be displayed. The change introduction interface 620 displays the change introduction from the change document that caused the changes shown in the updated segment 610.

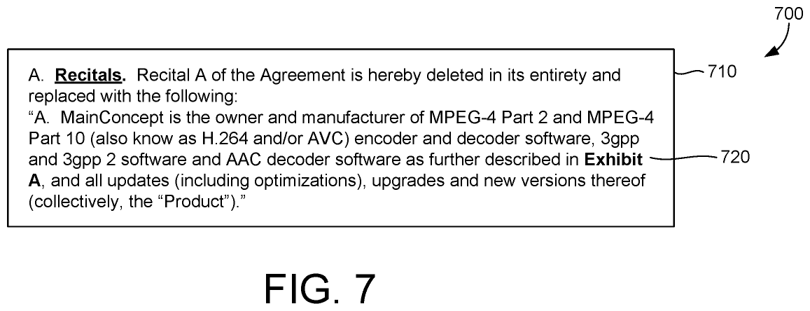

Turning now to FIG. 7, an illustration of a change document used to generate a multi-document interface is shown, according to aspects of the technology described herein. The change document 700 includes a change introduction 710 and change content 720. As can be seen, the change introduction 710 includes a section “A” in a clause title “recitals.” Both the section title and clause title can be used to identify the target element within the main contract.

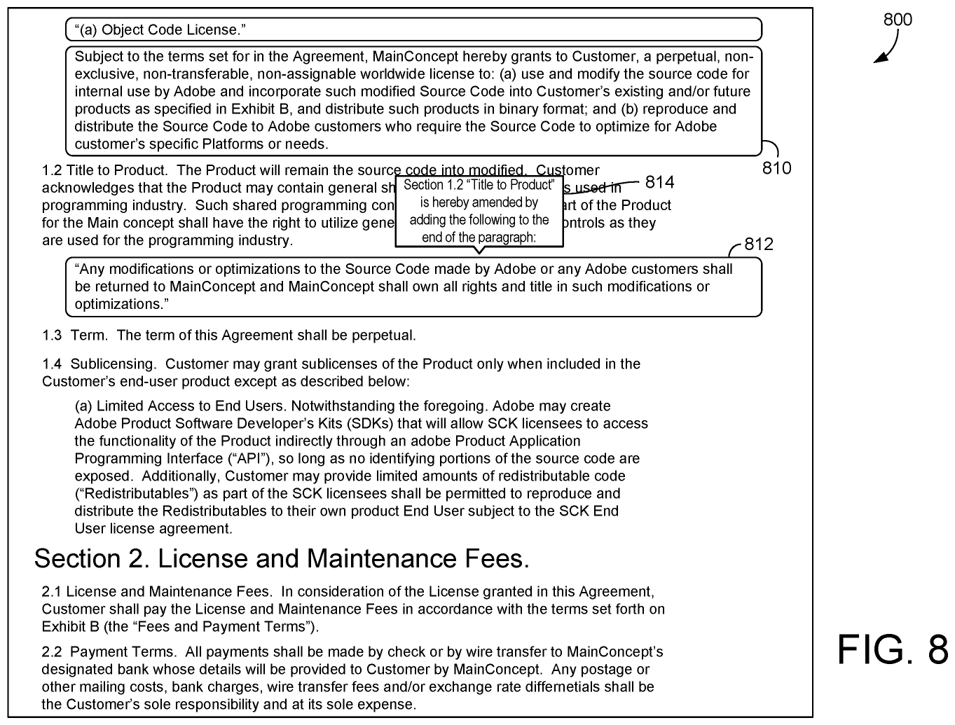

Turning now to FIG. 8, an illustration of an integrated-reading interface showing a unified contract view based on an insert is shown, according to aspects of the technology described herein. The integrated-reading interface 800 shows a first inserted paragraph 810 and a second inserted paragraph 812. Upon selecting the second inserted paragraph 812 the change introduction from the change document is displayed in a change introduction interface 814. The added paragraphs may be visually distinguished from paragraphs in the main contract by a bounding box, highlighting text, font choice, font size, italics, font color or some other mechanism.

Turning now to FIG. 9, an illustration of a section-update interface enabling user adjustment of document section identification is shown, according to aspects of the technology described herein. As described previously, various characteristics for segments in the change document and main contract may be determined. Each structural element (910 and 930) is outlined with colored border. The indentation level reflects their hierarchical ordering and can be changed by dragging the elements or by using the navigation buttons 918 (left, right, up, and down). A dropdown box 914 may be used to rectify the TYPE attribute for each of the detected elements. The user can also change the SECTION 916, TITLE LIST 920 and SECTION LIST 922 property for each element. While the TEXT attribute is not directly shown, the text 912 shown within each element reflects its value and is editable.

Turning now to FIG. 10, an illustration of change-document correction interface 1000 is shown, according to aspects of the technology described herein. The change document correction interface 1000 provide controls for correcting the TYPE attribute 1018, intent (‘add’ is shown which is equivalent to ‘Insert’) manually selecting a target element (‘Find segment in master contract’ button) 1016, change content (under the field ‘Context from the amendment’) 1020 and target location specifications 1022 by section or by titles 1024. The change content to be inserted is extracted from the element immediately succeeding the change introduction element 1010.

### METHODS

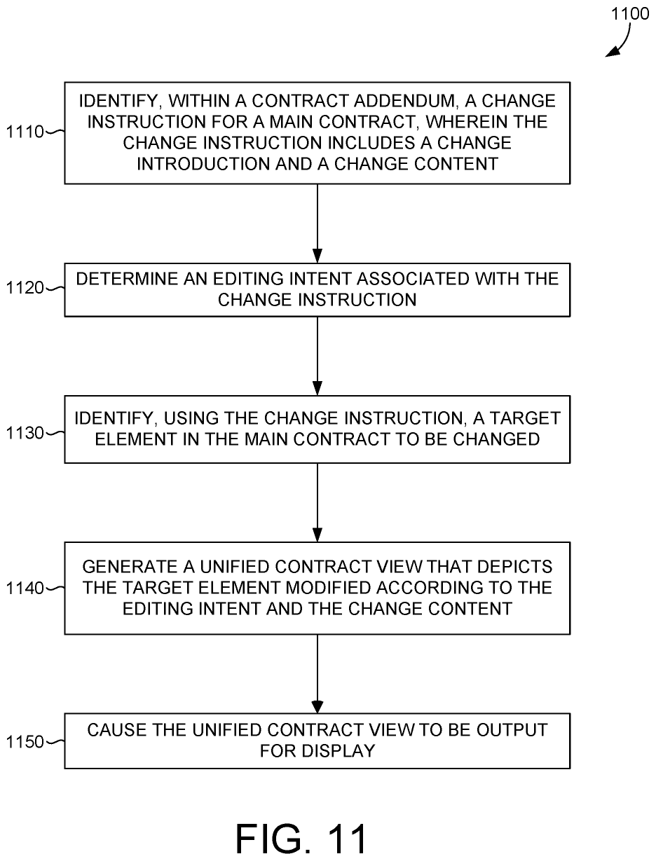

Now referring to FIGS. 11-13, each block of methods 1100, 1200, and 1300, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by a standalone application, a service or hosted service (standalone or in combination with another hosted service), to name a few. In addition, methods 1100, 1200, and 1300 are described, by way of example, with respect to the integrated reading system 110 of FIG. 1 and additional features of FIGS. 2-10. However, these methods may additionally or alternatively be executed by any one system, or any combination of systems, including, but not limited to, those described herein.

FIG. 11 is a flow diagram showing a method 1100 for generating an integrated-reading interface, in accordance with some embodiments of the present disclosure. The integrated-reading interface may be generated on a user device by an application running on the user device. The integrated-reading interface may be generated by a cloud-based service.

The method 1100, at block 1110, includes identifying, within a contract change document, a change instruction for a main contract, wherein the change instruction includes a change introduction and a change content. A change document may include multiple parts. For example, a change document may include introductory paragraph(s), change instructions (segments describing changes), concluding paragraph(s), and signature blocks. Introductory paragraphs may enumerate the parties concerned with the main contract, date of execution, and the like. Introductory paragraphs may include other information, such as a description of the rights and responsibilities of the parties. The one or more change instructions form the core of the change document. A change instruction describes the type of change (delete, insert, and replace) being made. The change instructions can include a change introduction followed by a change content portion. The change introduction can be used for identifying the intent. The change content defines that substantive change being made by the change instruction.

The method 1100, at block 1120, includes determining an editing intent associated with the change instruction. The editing intent may be found by mapping one or more words in the change instruction to a corresponding intent. Aspects of the technology may identify one of three different intents. The three intents include deleting, adding, and replacing. As described previously, the change-document intent finder 116 filters out the segments that do not describe change to identify change instructions. In one aspect, the change instruction is identified by detecting the presence of “action” words. The segments that describe the changes contain an action word that can be used for intent identification as well.

The method 1100, at block 1130, includes identifying, using the change instruction, a target element in the main contract to be changed. The target location is identified by analyzing change instruction details and contract segments details. A method of identifying the target element has been described previously with reference to the target location identifier 118.

The method 1100, at block 1140, includes generating a unified contract view that depicts the target element modified according to the editing intent and the change content. A unified contract view has been described previously, with reference to FIG. 8. The unified contract view shows the main document as modified by the change instruction(s) in one or more change documents. The unified contract view makes the main contract and change document readable as a single document. The unified contract view may show editing mark ups (e.g., underlining for new text, strikethrough for deleted text). Alternatively, the unified contract view may show a clean version that does not include editing mark up. In the clean view, deleted text is not shown and new text is displayed in the same format as original text in the main contract.

The method 1100, at block 1150, includes causing the unified contract view to be output for display. The unified contract view may be output as part of an integrated-reading interface. In addition to the unified contract view, the integrated-reading interface may include additional interface controls, including those used to select a main document and one or more change documents.

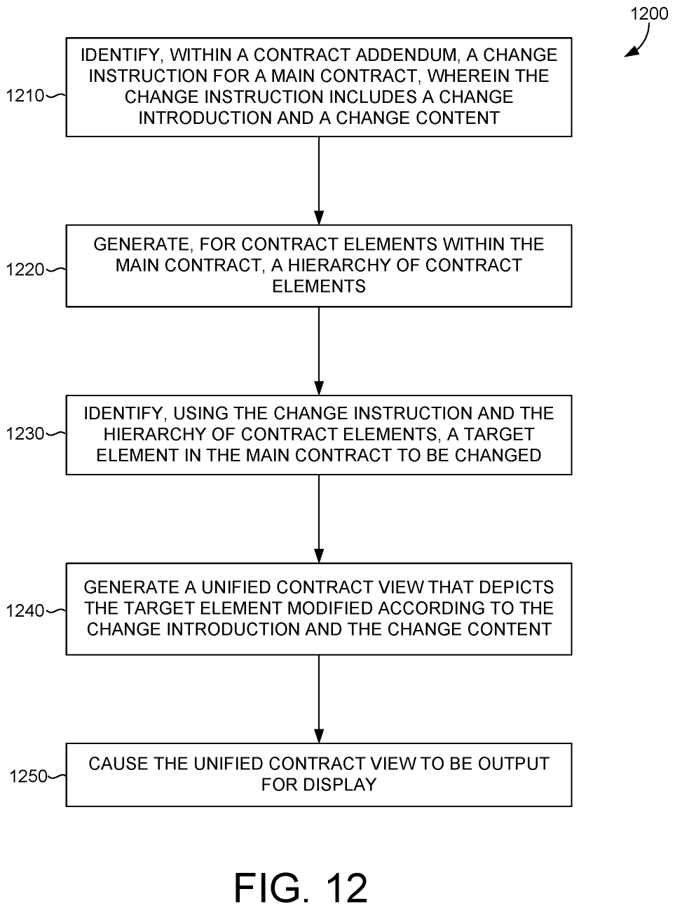

FIG. 12 is a flow diagram showing a method 1200 for generating an integrated-reading interface, in accordance with some embodiments of the present disclosure. The method 1200, at block 1210, includes identifying, within a contract change document, a change instruction for a main contract, wherein the change instruction includes a change introduction and a change content. A change document may include multiple parts. For example, a change document may include introductory paragraph(s), change instructions (segments describing changes), concluding paragraph(s), and signature blocks. Introductory paragraphs may enumerate the parties concerned with the main contract, date of execution, and the like. Introductory paragraphs may include other information, such as a description of the rights and responsibilities of the parties. The one or more change instructions form the core of the change document. A change instruction describes the type of change (delete, insert, and replace) being made. The change instructions can include a change introduction followed by a change content portion. The change introduction can be used for identifying the intent. The change content defines that substantive change being made by the change instruction.

The method 1200, at block 1220, includes generating, for contract elements within the main contract, a hierarchy of contract elements. The hierarchical order is based on the semantic structure associated with the document. The hierarchy of contract elements is generated by establishing hierarchical relations between the extracted structural elements. The semantic structure of the document is a collection and ordering of relationships among the structural elements (for instance, the containment relation between a clause and its sub-clauses). The semantic structure may be represented using a tree structure. This tree structure may incorporate detailed information with each structural element.

The method 1200, at block 1230, includes identifying, using the change instruction and the hierarchy of contract elements, a target element in the main contract to be changed. The target location is identified by analyzing change instruction details and contract segments details. A method of identifying the target element has been described previously with reference to the target location identifier 118.

The method 1200, at block 1240, includes generating a unified contract view that depicts the target element modified according to the change introduction and the change content. A unified contract view has been described previously, with reference to FIG. 8. The unified contract view shows the main document as modified by the change instruction(s) in one or more change documents. The unified contract view makes the main contract and change document readable as a single document. The unified contract view may show editing mark ups (e.g., underlining for new text, strikethrough for deleted text). Alternatively, the unified contract view may show a clean version that does not include editing mark up. In the clean view, deleted text is not shown and new text is displayed in the same format as original text in the main contract.

The method 1200, at block 1250, includes causing the unified contract view to be output for display. The unified contract view may be output as part of an integrated-reading interface. In addition to the unified contract view, the integrated-reading interface may include additional interface controls, including those used to select a main document and one or more change documents.

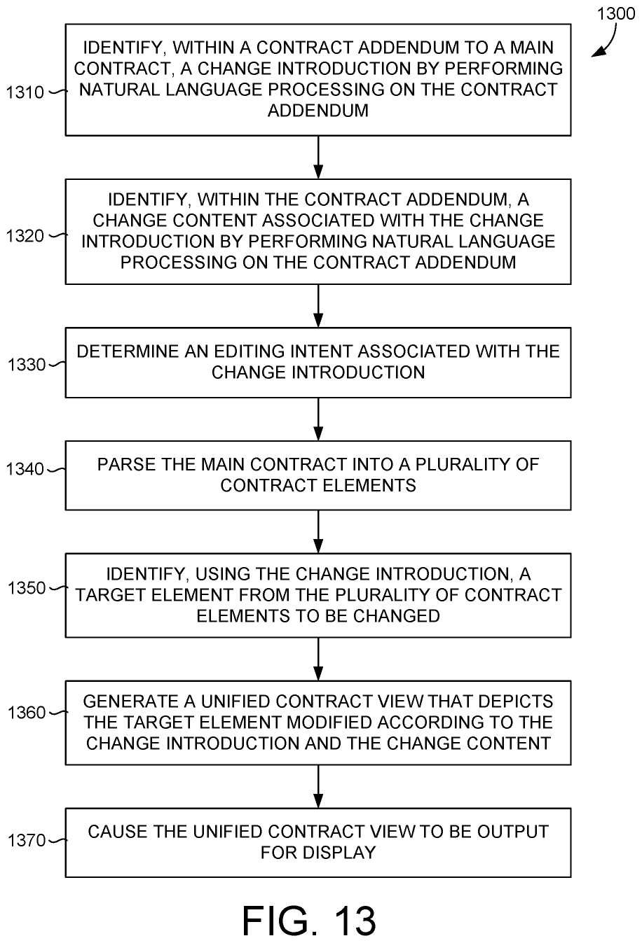

FIG. 13 is a flow diagram showing a method 1300 for generating an integrated-reading interface, in accordance with some embodiments of the present disclosure. The method 1300, at block 1310, includes identifying, within a contract change document to a main contract, a change introduction by performing natural language processing on the contract change document.

The method 1300, at block 1310, includes identifying, within the contract change document, a change content associated with the change introduction by performing natural language processing on the contract change document. A change document may include multiple parts. For example, a change document may include introductory paragraph(s), change instructions (segments describing changes), concluding paragraph(s), and signature blocks. Introductory paragraphs may enumerate the parties concerned with the main contract, date of execution, and the like. Introductory paragraphs may include other information, such as a description of the rights and responsibilities of the parties. The one or more change instructions form the core of the change document. A change instruction describes the type of change (delete, insert, and replace) being made. The change instructions can include a change introduction followed by a change content portion. The change introduction can be used for identifying the intent. The change content defines that substantive change being made by the change instruction.

The method 1300, at block 1320, includes determining an editing intent associated with the change introduction. The editing intent may be found by mapping one or more words in the change instruction to a corresponding intent. Aspects of the technology may identify one of three different intents. The three intents include deleting, adding, and replacing.

The method 1300, at block 1330, includes parsing the main contract into a plurality of contract elements. As described previously, the document segmenter 112 may generate a list of document segments within the change document.

The method 1300, at block 1340, includes identifying, using the change introduction, a target element from the plurality of contract elements to be changed. The target location is identified by analyzing change instruction details and contract segments details. A method of identifying the target element has been described previously with reference to the target location identifier 118.

The method 1300, at block 1350, includes generating a unified contract view that depicts the target element modified according to the change introduction and the change content. A unified contract view has been described previously, with reference to FIG. 8. The unified contract view shows the main document as modified by the change instruction(s) in one or more change documents. The unified contract view makes the main contract and change document readable as a single document. The unified contract view may show editing mark ups (e.g., underlining for new text, strikethrough for deleted text). Alternatively, the unified contract view may show a clean version that does not include editing mark up. In the clean view, deleted text is not shown and new text is displayed in the same format as original text in the main contract.

The method 1300, at block 1360, includes causing the unified contract view to be output for display. The unified contract view may be output as part of an integrated-reading interface. In addition to the unified contract view, the integrated-reading interface may include additional interface controls, including those used to select a main document and one or more change documents.

### EXAMPLE OPERATING ENVIRONMENT

Having briefly described an overview of embodiments of the present invention, an example operating environment in which embodiments of the present invention may be implemented is described below in order to provide a general context for various embodiments of the present invention. Referring initially to FIG. 14 in particular, an example operating environment for implementing embodiments of the present invention is shown and designated generally as computing device 1400. Computing device 1400 is but one example of a suitable computing environment and is not intended to suggest any limitation as to the scope of use or functionality of the invention. Neither should computing device 1400 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 14, computing device 1400 includes bus 1410 that directly or indirectly couples the following devices: memory 1412, one or more processors 1414, one or more presentation components 1416, input/output ports 1418, input/output components 1420, and illustrative power supply 1422. Bus 1410 represents what may be one or more buses (such as an address bus, data bus, or combination thereof). The various blocks of FIG. 14 are shown with lines for the sake of conceptual clarity, and other arrangements of the described components and/or component functionality are contemplated. For example, one may consider a presentation component such as a display device to be an I/O component. In addition, processors have memory. Such is the nature of the art, and reiterate that the diagram of FIG. 14 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 14 and reference to “computing device.”

Computing device 1400 typically includes a variety of computer-readable media. Computer-readable media can be any available media that can be accessed by computing device 1400 and includes both volatile and nonvolatile media, removable and non-removable media. By way of example, and not limitation, computer-readable media may include computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1400. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1412 includes computer storage media in the form of volatile and/or nonvolatile memory. The memory may be removable, non-removable, or a combination thereof. Example hardware devices include solid-state memory, hard drives, optical-disc drives, etc. Computing device 1400 includes one or more processors that read data from various entities such as memory 1412 or I/O components 1420. Presentation component(s) 1416 present data indications to a user or other device. Example presentation components include a display device, speaker, printing component, vibrating component, etc.

I/O ports 1418 allow computing device 1400 to be logically coupled to other devices including I/O components 1420, some of which may be built in. Illustrative components include a microphone, joystick, game pad, satellite dish, scanner, printer, wireless device, etc.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low-level functions relating, for example, to logic, control and memory operations. Low-level software written in machine code can provide more complex functionality to higher levels of software. As used herein, computer-executable instructions includes any software, including low level software written in machine code, higher level software such as application software and any combination thereof. In this regard, the system components ca manage resources and provide services for system functionality. Any other variations and combinations thereof are contemplated with embodiments of the present invention.

By way of example, the technical solution system can include an API library that includes specifications for routines, data structures, object classes, and variables may support the interaction between the hardware architecture of the device and the software framework of the technical solution system. These APIs include configuration specifications for the technical solution system such that the different components therein ca communicate with each other in the technical solution system, as described herein.

The technical solution system can further include a machine-learning system. A machine-learning system may include machine-learning tools and training components. Machine-learning systems can include machine-learning tools that are utilized to perform operations in different types of technology fields. Machine-learning systems can include pre-trained machine-learning tools that can further be trained for a particular task or technological field. At a high level, machine learning is a field of study that gives computers the ability to learn without being explicitly programmed. Machine learning explores the study and construction of machine-learning tools, including machine-learning algorithm or models, which may learn from existing data and make predictions about new data. Such machine-learning tools operate by building a model from example training data in order to make data-driven predictions or decisions expressed as outputs or assessments. Although example embodiments are presented with respect to a few machine-learning tools, the principles presented herein may be applied to other machine-learning tools. It is contemplated that different machine-learning tools may be used, for example, Logistic Regression (LR), Naive-Bayes, Random Forest (RF), neural networks (NN), matrix factorization, and Support Vector Machines (SVM) tools may be used for addressing problems in different technological fields.

In general, there are two types of problems in machine-learning: classification problems and regression problems. Classification problems, also referred to as categorization problems, aim at classifying items into one of several category values (for example, is this email SPAM or not SPAM). Regression algorithms aim at quantifying some items (for example, by providing a value that is a real number). Machine-learning algorithms can provide a score (e.g., a number from 1 to 100) to qualify one or more products as a match for a user of the online marketplace. It is contemplated that cluster analysis or clustering can be performed as part of classification, where clustering refers to the task of grouping a set of objects in such a way that objects in the same group (called a cluster) are more similar (in some sense) to each other than to those in other groups (clusters). It is a main task of exploratory data mining, and a common technique for statistical data analysis, used in many fields, including pattern recognition, image analysis, information retrieval, bioinformatics, data compression, computer graphics and machine learning.

Machine-learning algorithms utilize the training data to find correlations among identified features (or combinations of features) that affect an outcome. A trained machine-learning model may be implemented to perform a machine-learning operation based on a combination of features. An administrator of a machine-learning system may also determine which of the various combinations of features are relevant (e.g., lead to desired results), and which ones are not. The combinations of features determined to be (e.g., classified as) successful are input into a machine-learning algorithm for the machine-learning algorithm to learn which combinations of features (also referred to as “patterns”) are “relevant” and which patterns are “irrelevant.” The machine-learning algorithms utilize features for analyzing the data to generate an output or an assessment. A feature can be an individual measurable property of a phenomenon being observed. The concept of feature is related to that of an explanatory variable used in statistical techniques such as linear regression. Choosing informative, discriminating, and independent features is important for effective operation of the machine-learning system in pattern recognition, classification, and regression. Features may be of different types, such as numeric, strings, and graphs.

The machine-learning algorithms utilize the training data to find correlations among the identified features that affect the outcome or assessment. The training data includes known data for one or more identified features and one or more outcomes. With the training data and the identified features the machine-learning tool is trained. The machine-learning tool determines the relevance of the features as they correlate to the training data. The result of the training is the trained machine-learning model. When the machine-learning model is used to perform an assessment, new data is provided as an input to the trained machine-learning model, and the machine-learning model generates the assessment as output.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however, the distributed computing environment depicted herein is merely one example. Components can be configured for performing novel embodiments of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments that are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A method comprising:
identifying, within a contract change document, a change instruction for a main contract, wherein the change instruction includes a change introduction and a change content;
determining an editing intent associated with the change instruction;
identifying, using the change instruction, a target element in the main contract to be changed;
generating a unified contract view that depicts the target element modified according to the editing intent and the change content; and
causing the unified contract view to be output for display.

2. The method of claim 1, wherein the target element is associated with a part type, content, and a bounding box indicating a location for the target element within the main contract, and wherein the part type for the part type matches an expected part type identified in the change instruction.

3. The method of claim 1, wherein the method further comprises generating, for contract elements within the main contract, a hierarchy of contract elements according to a semantic structure of the main contract.

4. The method of claim 3, wherein the method further comprises building a title list for the target element by collating a title associated with the target element and a second title associated with a second contract element that is a parent node to the target element within the hierarchy of contract elements.

5. The method of claim 1, wherein the change document includes the change instruction and secondary content that does not define a change to the main contract, and wherein the secondary content is not included in the unified contract view.

6. The method of claim 1, wherein the editing intent is selected from a group consisting of a delete intent, a replace intent, and an insert intent.

7. The method of claim 1, wherein the further comprises receiving an interaction with the unified contract view and, in response, causing the change instruction to be output for display.

8. The method of claim 1, wherein the further comprises receiving a user interaction with a section-change interface and, in response to the user interaction, updating a characteristic of the target element.

9. A non-transitory computer-readable medium storing computer-executable instructions that, when executed by a processing device, cause the processing device to perform operations comprising:
identifying, within a contract change document, a change instruction for a main contract, wherein the change instruction includes a change introduction and a change content;
generating, for contract elements within the main contract, a hierarchy of contract elements;
identifying, using the change instruction and the hierarchy of contract elements, a target element in the main contract to be changed;
generating a unified contract view that depicts the target element modified according to the change introduction and the change content; and
causing the unified contract view to be output for display.

10. The non-transitory computer-readable medium of claim 9, wherein the method further comprises adjusting the hierarchy of contract elements in response to a user input provided through a section editing interface.

11. The non-transitory computer-readable medium of claim 9, wherein the method further comprises determining a section title from the change instruction.

12. The non-transitory computer-readable medium of claim 11, wherein the identifying the target element comprises matching the section title from the change instruction with an assigned title of the target element.

13. The non-transitory computer-readable medium of claim 9, wherein the target element is associated with a bounding box indicating a location for the target element within the main contract.

14. The non-transitory computer-readable medium of claim 13, wherein unified contract view comprises the main contract with the target element's content edited and displayed at the location instead of original content associated with the target element.

15. A system comprising:
a memory component; and
a processing device coupled to the memory component, the processing device to perform operations comprising:
identifying, within a contract change document to a main contract, a change introduction by performing natural language processing on the contract change document;
identifying, within the contract change document, a change content associated with the change introduction by performing natural language processing on the contract change document;
determining an editing intent associated with the change introduction;
parsing the main contract into a plurality of contract elements;
identifying, using the change introduction, a target element from the plurality of contract elements to be changed;
generating a unified contract view that depicts the target element modified according to the change introduction and the change content; and
causing the unified contract view to be output for display.

16. The system of claim 15, wherein the identifying the change introduction comprises identifying an editing verb within the change introduction from a plurality of designated verbs.

17. The system of claim 15, wherein the method further comprises determining a section title from the change introduction.

18. The system of claim 17, wherein the method further comprises building a title list for the target element by collating a title associated with the target element and a second title associated with a second contract element that is a parent node to the target element within a contract hierarchy.

19. The system of claim 18, wherein the identifying the target element comprises matching the section title from the change introduction with an assigned title of the target element.

20. The system of claim 15, wherein the change document includes the change introduction and secondary content that does not define a change to the main contract, and wherein the secondary content is not included in the unified contract view.
